(19) United States
(12) Patent Application Publication
(10) Pub. No.: US 2006/0113017 A1
(43) Pub. Date: Jun. 1, 2006

(54) Device for reducing the impact energy of tire and rim fragments

(75) Inventor: Oliver Seack, Bremen (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/017,502

(22) Filed: Dec. 20, 2004

(30) Foreign Application Priority Data
Dec. 22, 2003 (DE) 103 60 486.3

(51) Int. Cl. B60C 17/00; B60C 17/04; B60C 17/06; B29D 30/06

(52) U.S. Cl. 152/157; 156/113; 156/110.1; 152/450

(57) ABSTRACT

This invention relates to a device for reducing the impact energy of tire and rim fragments, comprising a rim with pneumatic tire mounted thereto, whose cavity is filled with a gas volume, wherein a displacer connected with the rim is arranged inside the tire cavity, and the displacer does not come into contact with the tire.

### BACKGROUND OF THE INVENTION

The present invention relates to the field of tires. In particular, the present invention relates to a device for reducing an impact energy of tire and rim fragments.

Pneumatic tires on all types of vehicles, such as land craft and aircraft, are subjected to significant loads during operation. In pressurized tires, minor damage to the running surface and/or flanks of the tire are often enough to cause the tire to burst given exposure to sudden mechanical loads, e.g., rolling over objects lying on the roadway. Tire fragments can be generated in the process, which are flung away at considerable speed due to the internal pressure and arising centrifugal forces, and seriously damage or endanger vehicle parts, objects and people upon striking them at a high speed. In particular in airplanes, the tires are subjected to significant loads during the takeoff and landing phase, and tire fragments from a burst tire pose a considerable danger. For example, the serious airplane accident involving the Concorde on Jul. 25, 2000 in Paris was caused by a metal strip lying on the runway, which damaged one of the tires on the Concord and caused it to burst during takeoff. A fragment of the tire in turn damaged the bottom of the wing, causing fuel to leak out and ignite the engine.

In addition to the potential bursting of a tire, material defects and/or damage can also cause the tire rim itself to fail. This can give rise to rim fragments, which can have a much more damaging effect than tire fragments, since rim fragments are denser and at times heavier than the tire fragments.

When an internally pressurized tire bursts and/or a tire rim breaks, the special danger stems from the explosively accelerated fragments, which can inflict great damage in close proximity to the tire due to impact.

EP 1186448, EP 0912354, FR 11322887, FR 2013313, and FR 369680 describe tires with damage protection.

### SUMMARY OF THE INVENTION

The present invention relates to a device for reducing the impact energy of tire and rim fragments, comprising a rim with pneumatic tire mounted thereto, whose cavity is filled with a gas volume, wherein a displacer connected with the rim is arranged inside the tire cavity, and does not come into contact with the tire. With the above exemplary embodiment of the present invention, it is believed that the effects caused by fragment impact may be reduced.

### BRIEF DESCRIPTION OF THE DRAWINGS

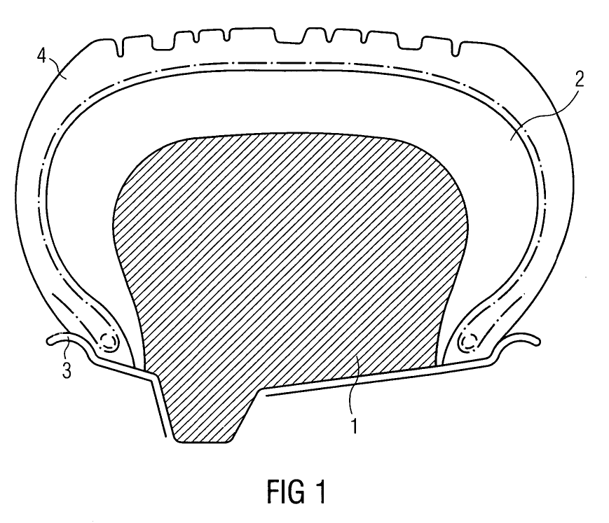

Attached FIG. 1 shows a typical cross section through a pneumatic tire with incorporated displacer. The displacer 1 typically takes up between about 10% and about 90% of the pressurized gas volume 2. The displacer 1 is situated inside the tire cavity, and here connected only with the rim 3, but not with the inside of the tire 4.

### DETAILED DESCRIPTION

EP 1186448 describes a pneumatic aircraft tire that is divided into segments with a defined size by means of predetermined breaking points. According to the instruction of this application, the size of a fragment given a burst tire along with its impact energy are to be limited by the suitable selection and arrangement of the predetermined breaking points.

It is believed that a disadvantage to the EP 1186448 is that it is only effective in case of tire failure. Given a rim failure, the proposed tire segmentation remains ineffective. Another disadvantage to this invention is believed to be the high manufacturing precision required to ensure that all predetermined breaking points fail simultaneously, so that only parts of minimal size as defined by the segments actually detach from the tire. Another problem may be that tire damage and resultant failure always starts locally, and not at several locations simultaneously. This stems not just from component-specific irregularities, but also has to do with the load leading to failure can only act locally, e.g., like the metal fragment, which in the end was the specific cause of the Concorde crash. Therefore, it is unlikely to realize a situation in practice where the predetermined breaking points provided in EP 1186448 would function in the desired way and actually result in the formation of fragments with a precisely defined size. Therefore, the instruction of EPA 1186448 does not make it possible to effectively limit the kinetic energy of the fragments.

EP 0912354B1, FR1 1322887, Fr 2013313 and FR 369680 describe resilient elements in the gas-filled interior of a tire in order to diminish the risk of damage to the tire cover by pointed or sharp objects by effectively thickening the tire wall, or impart certain emergency running properties to the tires given a sudden pressure loss.

None of these patents mentions the arrangement of elements within the air-filled tire in such a way as to reduce the pressure energy stored in the tire, and diminish the impact energy of tire or rim fragments in case of a burst.

Further, none of these patents mentions the arrangement of elements within the air-filled tire in such a way as to avoid contact with the tire itself.

It is believed that exemplary embodiments of the present invention provide means for effectively reducing the kinetic energy of tire or rim fragments given a burst tire or failed tire rim, thereby diminishing the effects of fragment impact.

Furthermore, it is believed that exemplary embodiments of the present invention provide means for reducing the kinetic energy of fragments that essentially have no effect on the running and damping properties of the pneumatic tire, or for impairing it.

Other exemplary embodiments of the present invention can be gleaned from the independent application claim. The subclaims describe further developments/embodiments of the invention which are believed to be advantageous.

The invention incorporates the technical instruction given a device for reducing the impact energy of tire and rim fragments according to the invention, comprising a rim with tire mounted thereto, in which the tire cavity is filled with a gas volume, and a displacer connected with the rim is arranged inside the tire cavity and does not come into contact with the tire. As a result of this solution, pressure energy stored in the tire is reduced overall by a decrease in the gas volume active inside the tire under an excess pressure. Given a failure of the tire and/or rim, the potential pressure energy stored in the tire along with the additionally acting centrifugal force from a possible wheel rotation must be regarded as the primary cause of fragment acceleration. In the case of a tire and/or rim failure, current linkage processes of the pressure fragments convert the potential pressure energy of the gas into the very kinetic energy of these fragments.

The potential energy Eₚ of a gas volume under an excess pressure measures
Eₚ=Δp*V (Eq. 1)

Here, V is the observed gas volume, and Δp is the differential pressure prevailing in the gas volume relative to the environment. A reduction in gas volume V leads to a proportional reduction in the potential energy Eₚ stored in the gas. As a result, correspondingly less energy is also available for subsequent conversion into the kinetic energy of the fragments, so that the fragment velocity will also be diminished.

The precise correlation between the potential energy of the gas volume and kinetic energy of the fragments is based upon complex, stochastic processes, which are influenced by the exact progression of damage to the tire and/or the rim in case of failure, and by the relative orientation of fragments relative to the exiting gas. This correlation is essentially unknown. However, it can be assumed in first approximation that the kinetic energy of the fragments Eₖ is roughly proportional to the potential energy Eₚ of the fill gas of the tire:
Eₖ˜Eₚ (Eq. 2)

This in turn results in a situation where halving the gas volume in the tire cuts the kinetic energy of the tire or rim fragments roughly in half. As a consequence, the fragments do correspondingly less damage on impact.

According to the invention, the effective gas volume is reduced by a displacer, which is incorporated into the pressurized gas volume of the tire.

The expert dimensions the displacer in a suitable manner, so that it takes up the greatest possible share of the gas volume in the tire cavity, but is dimensioned in terms of shape and size to essentially preclude contact between the displacer and the tire itself during wheel operation as a function of the used rim and tire geometry and the normally used gas pressure. As a result of this suitable dimensioning of size and volume relative to the displacer along with its connection with the rim without contact with the tire, so that there is no contact between the displacer and tire wall during normal tire operation, the running and damping properties of the original tire remain essentially intact, while the largest possible share of gas volume is simultaneously taken up by the displacer to minimize the potential pressure energy contained in the gas volume. This effectively diminishes the kinetic energy of fragments resulting from a tire or rim failure.

According to the invention, the displacer occupies up to 90% of the pressurized gas volume in the tire, typically between approx. 10% and approx. 90%.

The displacer is here connected only with the rim, but not with the inside of the tire.

The displacer material is not critical with respect to this invention. Suitable materials can be resilient or rigid, completely tight or porous. Because it is preferred in terms of the invention that the displacer material take up as much volume as possible, it should most ideally be completely tight.

In a particularly preferred embodiment of this invention, the displacer and rim are designed as a single, integral component. In this case, the displacer can consist of a metal piece welded to the running surface of the rim as a tube, which takes up as much of the tire cavity volume as possible, wherein the displacer can itself be hollow inside. The connection between the displacer and rim must here be gastight.

The solution according to the invention offers an entire range of advantages:

The factors underlying the risk of impact damage from tire and rim fragments is reduced at the source. This eliminates the need for massively protecting any areas that may potentially be affected by impact damage against impact damage, as would have to be done were the conventional tire construction to be retained.

In aircraft, the affected areas could only be protected by significantly increasing the structural weight in light of the dimensional scope (large parts of the fuselage, underside of wings, lifting system, landing gear and propulsion unit).

By contrast, the solution according to the invention has little or no influence on the weight of the aircraft.

In other areas of application, e.g., utility vehicles for chemical plants, protection is practically impossible to provide by way of the size and scope of the system components. The approach pursued according to the invention of minimizing the cause of impact damage at its source limits the necessary measures to the pressure volume of the tires, which is very small by comparison to the size of the areas at risk. This also minimizes the cost associated with the safety measure.

In addition, the consequences of impact damage caused by fragments of tires and rims alike are simultaneously diminished, not just the effect of tire damage alone, as described, for example, in EP 1186448.

Furthermore, the mode of operation relative to this invention is essentially independent of production tolerances and a power supply, as well as of the operation of other mechanical, electromechanical and electronic systems, which in turn are themselves subject to failure risks.

The pressure required to operate the tire can remain unchanged. Furthermore, the construction and production principles existing at present need not be modified for a gas-filled tire under excess pressure.

The solution according to the invention can also be retrofitted into already built and operated vehicles, such as aircraft and land craft.

In addition, the advantage to the solution according to the invention is that the displacer does not impair the running and damping properties of the tire during normal operation, since it does not come into contact with the tire wall.

The area of application for this invention encompasses all gas-filled tires of vehicles, such as aircraft or land craft, especially in safety applications, where damage caused by burst tires and rim breakage can lead to in part catastrophic consequences.

These include aircraft whose air-filled tires can damage large areas of the airframe with critical safety-related structures or systems if they burst during takeoff, landing or during flight. Safety-critical structures primarily include the internally pressurized fuselage with passenger cabin, and the wings filled with aviation fuel. The at-risk safety-critical systems include all electrical, hydraulic and fuel-carrying lines located in the at-risk area, the complete landing gear itself, the propulsion units and the entire lifting system with drive trains, sensors, support structure, the actual landing flaps and slats.

Another area of application for this invention involves vehicles operated in areas critical in terms of safety, e.g., at industrial or chemical plants. Here as well, bursting tires or broken rims and scattering fragments thereof can cause damage, in some cases with severe repercussions.

In addition, using this invention in disaster control vehicles, e.g., fire trucks, which often are operated under conditions characterized by tire-damaging objects on the ground and at times elevated temperatures, where personnel must concurrently work in an area at risk for flying tire or rim fragments.

In these areas of application, the invention introduced here can greatly diminish the damaging consequences of fragments generated by burst tires and broken rims, and significantly reduce the arising impact damages.

The underlying principle of this invention will be described in greater detail based on the attached FIG. 1.

In terms of its configuration, the invention is not limited to the preferred embodiment shown in the figure. Rather, a plurality of variants is conceivable, making use of the described solution and inventive principle even given embodiments of fundamentally differing configuration.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

What is claimed is:

1. A device for reducing an impact energy of tire and rim fragments, the device comprising:
a rim with a pneumatic tire mounted thereto;
wherein the pneumatic tire has a cavity which is filled with a gas volume;
a displacer connected to the rim; wherein the displacer is arranged inside the tire cavity; and
wherein the displacer is adapted such that there is no contact to the tire.

2. The device of claim 1, wherein the displacer is dimensioned to take up the greatest possible share of the gas volume in the tire cavity and simultaneously essentially preclude contact between the displacer and the tire during operation of the device in vehicles.

3. The device according to claims 1 or 2, wherein the displacer occupies up to 90% of the gas volume in the tire, the gas volume being pressurized.

4. The device of claim 1, wherein the displacer is made of a material selected from the group consisting of a resilient material, a rigid material, an openly porous material and a closed porous material.

5. The device of claim 1, wherein the displacer and the rim are arranged as a single, integral component.

6. The device of claim 1, wherein the vehicle is an aircraft or a land vehicle.

7. A method for reducing the impact energy of tire or rim fragments given a burst tire or rim failure comprising providing a displacer inside a tire cavity in a vehicle having a rim with a gas-filled tire mounted thereto.

8. The method of claim 7, wherein the vehicle wheel is an aircraft wheel or a land vehicle wheel.

9. The method of claim 7, wherein the displacer is connected to the rim without coming into contact with the gas-filled tire.
